(19) United States
(12) Patent Application Publication
(10) Pub. No.: US 2024/0270641 A1
(43) Pub. Date: Aug. 15, 2024

(54) Cement plastic mixture

(71) Applicant: Terratico, j.s.a., Zilina (SK)

(72) Inventors: Otto Nagy, Horny Bar (SK); Otto Nagy, Horny Bar (SK)

(21) Appl. No.: 18/567,407

(22) PCT Filed: Jun. 7, 2022
(86) PCT No.: PCT/SK2022/000004

§ 371 Date: Dec. 6, 2023

(30) Foreign Application Priority Data
Jun. 7, 2021 (SK) PP 42-2021
Jun. 7, 2021 (SK) PUV 81-2021

(51) Int. Cl. C04B 18/20; C04B 14/06; C04B 18/14; C04B 20/00; C04B 28/04; C04B 103/12; C04B 103/32

(52) U.S. Cl. CPC C04B 18/20; C04B 14/06; C04B 18/146; C04B 20/0048; C04B 28/04; C04B 2103/12; C04B 2103/32

(57) ABSTRACT

The cement plastic mixture may contain 29% of weight to 43% of weight of plastic crumb, 56% of weight to 69% of weight of cement and 1.0% of weight to 2.0% of weight of superplasticizer with addition of 6.0% of weight to 12% of weight of sand with a fraction 0.3 mm to 2.0 mm and 4.0% of weight to 14.0% of weight of water.

### RELATED APPLICATIONS

This application is a national stage application of international patent application PCT/SK2022/000004, filed Jun. 7, 2022, which claims priority to Slovakia Patent Application No. PP 42-2021, filed Jun. 7, 2021, and to Slovakia Patent Application No. PUV 81-2021, filed Jun. 7, 2021, all of which are hereby incorporated by reference in their entirety.

### FIELD OF TECHNOLOGY

The invention relates to a cement plastic mixture usable for the production of construction and stone products. The invention falls into the field of construction and stonework.

### BACKGROUND

At present, products based on cement, silica sand and stone, granite or marble crumb such as e.g. terrazzo are known in the field of construction and stonework. Terrazzo is a composite material, poured in place or precast, which is used for floor and wall treatments. It comprises chips of marble, quartz, granite, glass, or other suitable material, poured with a cementitious binder (for chemical binding), polymeric (for physical binding), or a combination of both.

The document RU 2739910 C1 is known in the prior art, which describes a polymer-cement dry construction mixture which contains Portland cement, a polymeric binder, sand, glass fiber and a modifier. The polymeric binder is redisperible polyvinyl acetate polymer powder or polyvinyl acetate copolymers.

Two-component fast-setting plastic cement is also known from the document CN 112063160 A, where the first component is a polyether polyol, a curing agent, a surface hydroxylated modified paraffin, a thickener and a solid filler. The second component is a polyether polyol, a catalyst, a crosslinking agent paraffin modified by a surface hydroxyl group, a thickener and a solid. Paraffin with certain hydroxyl content is introduced into these two components.

There were also tendencies to mix acrylate rubber asphalt into the cement, as is the case with the utility model SK 1692 U, in order to reduce the bulk density, increase the thermal insulation properties and ensure water impermeability.

A building mix comprising cement and paper pulp is also known, as described in utility model SK 4239 U, which saves on production costs and reduces the weight of the product.

The problem of cement mixtures, which has not yet been fully explored, has at present evoked to design such a composition of the cement mixture that would also allow the ecological use and consumption of plastic waste. The result of this effort is the cement plastic mixture described in the present invention.

### DETAILED DESCRIPTION

The above-mentioned problem of cement mixtures is solved by the proposed cement plastic mixture according to the invention in dry or wet form. The essence of the technical solution lies in the fact that, depending on the composition, the dry mixture contains three basic components. It is a mixture that contains crushed plastics preferably which cannot be further recycled. It is possible to use plastics of all kinds with a fraction of 1 mm to 20 mm, or even a higher fraction, or chopped plastic strips, except for plastic pellets. May also be cement, preferably Portland gray or white with a strength of 32.5 MPa to 52.5 MPa.

Portland grey and Portland white represent historical names for a cement which may be used as a synonym for hydraulic binder.

Finally, it may be a superplasticizer, preferably a superplasticizer with a density of 10/40 (40% of superplasticizer). According to the present invention the superplasticizer may be based on or may comprise or may be made from melamine formaldehyde and or may fulfill the EN 934-2 2019+A1:2012 standard and/or may fulfill the EN 934-2+A1 standard. This dry cement plastic mixture can be packaged e.g. into paper bags and at the point of use it preferably may only be mixed with water. Depending on the consumer's needs, additional components can be added to these three basic components, such as: silica sand preferably with a fraction of 0.3 mm to 2.0 mm and/or solidification accelerator, e.g. Betodur A5, thus a chloride free concrete and/or synthetic fibers, e.g. ARC 42/30 mm, namely alkali resistant (AR) Glass Fibers, which may be designed specifically for use in concrete and/or powdery paint, e.g. in the form of dry color pigment powder for concrete. In the case of a wet cement plastic mixture, which is mixed at the place of use or production, water may also be considered as an additional component.

The essence of the invention is represented by the composition of individual components of the cement plastic mixture. The cement plastic mixture in basic components comprises according to a preferred embodiment:
29% of weight to 43% of weight of plastic crumb;
56% of weight to 69% of weight of cement; and
1.0% of weight to 2.0% of weight of superplasticizer adding up to 100% and representing a basic mixture.

Further, to the weight of the basic mixture, at least one additional ingredient may be added comprising or consisting of:
6.0% of weight to 12% of weight of silica sand; and/or
0.4% of weight to 0.9% of weight of solidification accelerator; and/or
0.04% of weight to 0.07% of weight of ARC synthetic fibers; and/or
0.02% of weight to 0.08% of weight of paint; and/or
4.0% of weight to 14.0% of weight of water; and/or
4.0% of weight to 10% of weight of silica fume (microsilica) SiO₂ of weight of cement.

The percent of weight of additional ingredients according to the present invention is meant as a percentage that is additional to the weight of the basic mixture such that the final product has Y weight units (e.g, kilogram(s)) of basic mixture+e.g., 6% additional weight of additional ingredients adding up to a total mass Y*1.06 of the mass of the basic mixture according to this example.

Thus, the weight percentage of additional ingredients comes on top of the mass of the basic mixture and is calculated as if the basic mixture without the additional ingredients was 100% leading in the above example to a total final product (cement plastic mixture) mass of 106% with respect to the mass of the basic mixture.

The advantages of the cement plastic mixture according to the invention are evident from its external effects. The effects and originality lie in its unique composition, where the goal of cement plastic mixture is to save costs by using cheap input raw material-plastic waste as well as reducing the weight of the resulting product. An undeniable benefit is the fact that the screeds comprising this cement plastic mixture look like terrazzo.

Terrazzo is a composite material, poured in place or precast, which is used for floor and wall treatments. It comprises chips of marble, quartz, granite, glass, or other suitable material, poured with a cementitious binder (for chemical binding), polymeric (for physical binding), or a combination of both.

This effect is achieved by replacing marble crumb with plastic waste crumb, which reduces costs by up to 80%. Products made of cernent plastic mixture according to the invention leave a lower carbon footprint and at the same time solve the problem of one of the most difficult to recycle plastic waste. Even decades old degraded plastic, even if exposed to sunlight, can be processed in this way. The addition of plastic crumb may give the product a surface structure mosaic and/or the addition of synthetic fibers may give the product flexibility to prevent cracking. The addition of silica sand may add stiffness to the product.

From this cement plastic mixture according to the invention, it is possible to produce garden furniture, e.g. benches, flower pots, rubbish baskets, tables, large-format paving, facade elements and cast prefabricated parts, that can be cut, sanded, sandblasted, impregnated, and similarly machined with chip or non-chip technologies.

### Example of an Embodiment of the Invention

It is understood that the individual embodiments of the cement plastic mixture according to the invention are presented for illustration and not as limitations of solutions. Those skilled in the art will find, or be able to ascertain using no more than routine experimentation, many equivalents to specific embodiments of the cement plastic mixture according to the invention. Such equivalents wall also fall within the scope of the claims.

It is not a problem for those skilled in the art to optimally mix the individual components of the cement plastic mixture, so these features have not been addressed in detail.

### Example 1

In this example of a specific embodiment of the invention, namely a cement plastic mixture or a dry standard cement-plastic mixture preferably for products with a surface finish by grinding, preferably packed in paper bags, intended mainly for small consumers is described. Dry base cement plastic mixture (basic mixture) contains:
19 kg of plastic crumb, which is 42.7% of weight;
25 kg of gray cement 42.5 (alternatively of gray cement 52.5), which is 56.1% of weight; and
0.5 kg of superplasticizer 10/40 (density), which is 1.2% of weight.

### Example 2

In this example of a specific embodiment of the invention, namely a cement plastic mixture or a dry standard cement-plastic mixture preferably for products with a sanding/grinding finish, packed in paper bags, intended mainly for small consumers is described. Dry base cement plastic mixture (basic mixture) contains:
19 kg of plastic crumb, which is 42.7% of weight;
25 kg of gray cement 42.5 (alternatively of white cement 52.5), which is 56.1% of weight; and
0.5 kg of superplasticizer which is 1.2% of weight.

These three basic components represent 100% of weight of the basic mixture to which at least one of the following additives may be added:
3 kg of silica sand with a fraction 0.8 mm, which is 6.7% of weight; and/or
0.2 kg of solidification accelerator Betodur A5, which is 0.47% of weight; and/or
0.022 kg of ARC synthetic fibers 42/30, which is 0.05% of weight; and/or
0.004 kg of paint, which is 0.01% of weight.

Thus, paint (if one desires different color) (optional) and/or solidification accelerator (e.g. the shape of casted mold requires a less liquid final mixture) (optional) and/or synthetic fibers (if the end product requires more resistance to mechanical damage) (optional) and/or silica sand.

### Example 3

In this example of a specific embodiment of the invention as a wet basic as well as standard cement plastic mixture, namely a wet cement plastic mixture, preferably for products with a sanding/grinding finish. The basis is the dry mixtures described in Examples 1 and 2, further supplemented with 5 liters of water, which represents 11.2% additional weight on top of the mass of the dry basic mixture.

### Example 4

In this example of a specific embodiment of the invention, namely a cement plastic mixture dry basic cement plastic mixture (basic mixture) for unground products preferably packed in paper bags intended in particular for small consumers is described. The dry basic cement plastic mixture contains:

16 kg of plastic crumb, which is 38% of weight;

25 kg of gray cement 42.5 (alternatively of gray cement 52.5), which is 60.1% of weight; and
0.8 kg of superplasticizer Melment 20/40, which Is 1.9% of weight.

### Example 5

In this example of a specific embodiment of the invention, namely a cement plastic mixture, dry base cement plastic mixture for unground products preferably packed in paper bags intended in particular for small consumers is described. The dry basic cement plastic mixture contains:
16 kg of plastic crumb, which is 38% of weight;
25 kg of gray cement 42.5 (alternatively of white cement 52.5), which is 60.1% of weight; and
0.8 kg of superplasticizer 20/40, which is 1.9% of weight.

These three basic components represent 100% of weight of the basic mixture to which additives are added comprising or consisting of:
5 kg of silica sand with a fraction 0.8 mm, which is 12% of weight; and/or
0.4 kg of solidification accelerator Betodur A5, which is 0.9% of weight; and/or
0.022 kg of ARC synthetic fibers 42/30, which is 0.005% of weight; and/or
0.004 kg of paint, which is 0.01% of weight; and/or
2.5 kg of silica fume (microsilica) SiO₂, which is 10% of weight of cement.

### Example 6

In this example of a specific embodiment of the invention, wet basic as well As standard cement plastic mixture, namely a wet cement plastic mixture for unground products is described.

The basis is either one of the mixtures described in Examples 4 and 5, the further addition being 1.7 liters of water, which represents 4% additional weight on top of the mass of the dry basic mixture.

### INDUSTRIAL APPLICABILITY

The cement plastic mixture according to the present invention is intended for the field of construction and stonework.

1. A composition of matter comprising:
a basic mixture of 29% of weight to 43% of weight of plastic crumb;
56% of weight to 69% of weight of cement; and
1.0% of weight to 2.0% of weight of superplasticizer adding up to a total of 100% weight of the basic mixture.

2. The composition of matter of claim 1, further comprising:
6.0% of weight to 12% of weight of silica sand; and
a fraction 0.3 mm to 2.0 mm on top of the weight of the basic mixture.

3. The composition of matter of claim 1, further comprising 0.4% of weight to 0.9% of weight of solidification accelerator on top of the weight of the basic mixture.

4. The composition of matter of claim 1, further comprising 0.04% of weight to 0.07% of weight of ARC synthetic fibers on top of the weight of the basic mixture.

5. The composition of matter of claim 1, further comprising 0.01% of weight to 0.08% of weight of paint on top of the weight of the basic mixture.

6. The composition of matter of claim 1, further comprising 4.0% of weight to 14.0% of weight of water on top of the weight of the basic mixture.

7. The composition of matter of claim 1, further comprising: 4.0% of weight to 10% of weight of silica fume (microsilica) SiO₂ of weight of cement on top of the weight of the basic mixture.
